(19) United States
(12) Patent Application Publication
(10) Pub. No.: US 2026/0151715 A1
(43) Pub. Date: Jun. 4, 2026

(54) EXTRACTION AND SEPARATION OF GUMS FROM OLEAGINOUS MATERIAL USING AN ALCOHOL SOLVENT

(71) Applicant: Crown Iron Works Company LLC, Blaine, MN (US)

(72) Inventors: Wade Steven Martinson, Minneapolis, MN (US); Revathi Panuganti, Minneapolis, MN (US); Nicholas Ollila, Fridley, MN (US)

(21) Appl. No.: 19/404,826

(22) Filed: Dec. 1, 2025

Related U.S. Application Data
(60) Provisional application No. 63/726,531, filed on Nov. 30, 2024.

(51) Int. Cl. B01D 11/02; C11B 1/10

(52) U.S. Cl. CPC B01D 11/0292; B01D 11/0223; B01D 11/028; B01D 11/0288; C11B 1/108

(57) ABSTRACT

Systems and techniques can be used to extract and recover gums from oleaginous material. In some examples, the oleaginous material is extracted with an alcohol-containing solvent to generate a miscella stream containing extracted oil and gums. The miscella is cooled to a first temperature to form a phase separation and the resulting solvent-rich phase is then cooled to a second temperature to precipitate gums in the solvent-rich phase. The precipitated gums can then be separate from the solvent-rich phase, e.g., through filtration. By extracting and separating the gums during solvent extraction, the oil recovered through the extraction process can be used or processed without undergoing a separate degumming step.

### CROSS-REFERENCE

This application claims priority to and the benefit of U.S. Provisional Patent Application No. 63/726,531, filed Nov. 30, 2024, the entire contents of which are incorporated herein by reference.

### TECHNICAL FIELD

This disclosure relates to solvent extraction and, more particularly to liquid-solvent extraction using an alcohol-based solvent.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. During operation, the selected feedstock is passed through the extractor and contacted with a solvent. The solvent can extract oil out of the feedstock to produce an oil deficient solids discharge and a miscella stream. The miscella stream can contain the solvent used for extraction and oil extracted from the feedstock. The oil can be further processed before end sale and end use.

For edible oils, one of the key steps in the refining process is the elimination of impurities from crude vegetable oils especially the phosphatides or so-called gums. Gums are mainly present in oils extracted with solvent from soybeans, sunflower seed, and rapeseed. It is desirable to remove the gums during the oil refining because gums exhibit emulsifying properties, causing refining losses. Also, because gums are thermally unstable, the gums can decompose, resulting in undesirable darkening of the oil.

### SUMMARY

In general, this disclosure is directed to devices, systems, and techniques, for processing an oil-containing material with an alcohol-based solvent to extract oil from the material. In some examples, a system includes an extractor configured to process an oil-containing feedstock. The extractor receives the oil-containing feed stock and conveys the material from an inlet to an outlet through the extractor. The extractor also receives an alcohol-based solvent at a solvent inlet and conveys the solvent through the extractor to a solvent outlet. The alcohol-based solvent may travel in a countercurrent direction through the extractor from a direction of material travel that the feedstock travels through the extractor. In either case, a concentration of oil in the feedstock may decrease as the feedstock moves through the extractor from the inlet to the outlet. This results in the concentration of oil in the solvent increasing as the solvent moves through the extractor from the solvent inlet to the solvent outlet. In addition to extracting oil from the feedstock, the solvent can extract gums from the feedstock.

The solvent stream containing extracted oil and gums from the feedstock is referred to as miscella. The miscella can be processed to separate the solvent from the extracted oil and to further precipitate the gums extracted from the oleaginous feedstock into the solvent. The precipitated gums can then be separated from the solvent, producing a separate high-value extracted gums stream from the process and eliminating the need for the extracted oil to undergo a separate gums extraction process during downstream oil refining. This can reduce or eliminate the need for downstream degumming of the extracted oil stream (the oil stream separated from the miscella).

By efficiently controlling the precipitation and separation of the gums from the miscella stream, a separated gums stream can be generated that contains a very low amount of entrained oil compared to a gums stream generated in a traditional hexane extraction process that uses a downstream water degumming process. This reduces the amount of oil loss attributable to oil entrainment in the separated gums stream, increasing the relative amount of extracted and separated oil generated by the process and enhancing the overall economics of the process.

In some examples, an extraction system can utilize an extractor to generate an oil-containing and gums-containing solvent stream called the miscella and an oil-deficient solids stream carrying entrained solvent called a marc. To separate the oil from the solvent in the miscella stream, the miscella stream may be cooled to a temperature effective to cause phase separation between the polar solvent and the oil in the stream. The solvent-rich phase and the oil-rich phase formed via cooling can then be separated, e.g., using a decanter. This can produce a separated oil-rich stream and a separated solvent-rich stream. When cooling to cause phase separation, the miscella stream may be cooled to a temperature above that at which gums in the polar solvent portion of the miscella substantially precipitate. That is, the majority of the gums in the miscella may remain solubilized in the solvent, although some portion of the gums may precipitate depending on the cooling temperature. As a result, the gums can remain dissolved in the polar solvent portion of the miscella and remain in the solvent-rich phase as opposed to the oil-rich phase. Consequently, a majority of the gums in the miscella phase can carry into the separated solvent-rich stream following separation of the solvent-rich phase and the oil-rich phase. In some applications, multiple stages of separation may be implemented to enhance separation of the gums from the oil-rich phase.

Independent of how the solvent-rich phase is separated from the oil-rich phase to form a separated oil-rich stream and a separated solvent-rich stream, systems and techniques of the disclosure can cool the separated solvent-rich stream to a second temperature less than a first temperature to which the full miscella stream was cooled. The second temperature can be sufficiently low to precipitate the extracted gums in the separated solvent-rich stream. The precipitated extracted gums can then be separated from the solvent-rich stream, e.g., via filtering, centrifugation, and/or other mechanical separation techniques.

In practice, when the separated solvent-rich stream is cooled to precipitate the extracted gums, at least some portion of the residual oil in the separated solvent-rich stream may solidify, agglomerate, and/or further phase separate from the polar solvent portion of the separated solvent-rich stream. This residual separated oil can complicate separation of the precipitated extracted gums from the remaining portion of the solvent-rich stream, e.g., by plugging a filter or other mechanical separation device separating the precipitated extracted gums from the remainder of the solvent-rich stream. In these and other applications, systems and techniques of the disclosure may heat the solvent-rich stream containing the precipitated extracted gums prior to separating the precipitated extracted gums from the solvent-rich stream. For example, the solvent-rich stream containing the precipitated extracted gums may be heated to a temperature effective to solubilize residual oil that was phase separated upon cooling the stream to precipitate the extracted gums. The temperature to which the stream is heated may, however, be below a temperature effective to substantially redissolve the precipitated extracted gums. In this way, the phase separated oil can be redissolved in the solvent-rich stream with minimizing redissolution of the precipitated extracted gums. Once suitably heated, the precipitated extracted gums can then be separated from the heated solvent-rich stream.

In one example, a method is described that involves conveying an oleaginous material to be processed in a conveyance direction through an extractor and conveying a solvent comprising alcohol in a countercurrent direction from the conveyance direction through the extractor, thereby generating an extracted material stream and a miscella stream comprising extracted oil and extracted gums. The method involves cooling the miscella stream to a first temperature to form a solvent-rich phase that includes the extracted gums dissolved in the solvent-rich phase and an oil-rich phase that includes the extracted oil. The method includes separating the solvent-rich phase from the oil-rich phase to form a separated oil-rich stream and a separated solvent-rich stream. The method further includes cooling the separated solvent-rich stream to a second temperature less than the first temperature, the second temperature being effective to precipitate the extracted gums in the separated solvent-rich stream thereby forming precipitated extracted gums. The example method also includes separating the precipitated extracted gums from the separated solvent-rich stream.

In another example, a method is described that includes extracting oil and gums from an oleaginous material using a solvent that includes alcohol to form an extracted material stream and a miscella stream that includes extracted oil and extracted gums. The method includes cooling the miscella stream to a first temperature to form a solvent-rich phase that includes the extracted gums dissolved in the solvent-rich phase and an oil-rich phase that includes the extracted oil. The method also includes separating the solvent-rich phase from the oil-rich phase to form a separated oil-rich stream and a separated solvent-rich stream and cooling the separated solvent-rich stream to a second temperature less than the first temperature and thereby precipitating the extracted gums in the separated solvent-rich stream thereby forming precipitated extracted gums and further causing phase separation of residual oil carried with the separated solvent-rich stream. The example method further involves heating the separated solvent-rich stream to cause the residual oil phase separated when cooling the separated solvent-rich stream to the second temperature to solubilize without substantially dissolving the precipitated extracted gums and separating the precipitated extracted gums from the separated solvent-rich stream.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example extractor system according to the disclosure.

FIG. 2 is an illustration of an example extractor configuration that can be used in the system of FIG. 1.

FIG. 3 is a plot of experimental gums yield data showing the amount of precipitated gums recovered at different cooling temperatures.

FIG. 4 is a block diagram illustrating an example configuration of the extraction system from FIG. 1.

FIG. 5 is a block diagram illustrating a portion of the extraction system from FIGS. 1 and 4 showing an example arrangement of processing steps that can be implemented to process the miscella received from the extractor.

FIG. 6 is a block diagram illustrating another configuration of the example portion of extraction system from FIG. 1 and FIG. 4.

### DETAILED DESCRIPTION

In general, the disclosure relates to liquid-solid extractor systems and processes that enable the extraction of one or more desired products from solid material flows. In some examples, the solid material is processed in a continuous flow extractor that conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 15 minutes to 3 hours, such as from 1 hour to 2 hours.

The solvent discharged from the extractor, which may be referred to as a miscella, contains extracted oil and extracted gums. Gums extracted from oleaginous material (e.g., oil seeds) are primarily phospholipids. The phospholipids may include phosphatides (e.g., forming the cell wall of the oil seed) that also contains entrained oil and meal particles. The gums can form when the oil absorbs water that causes some of the phosphatides to become hydrated and thereby oil-insoluble. Hydrating the gums and removing the hydrated gums from the oil can prevent the formation of a gum deposits, e.g., while the oil is in storage.

In traditional organic solvent extraction (e.g., hexane-based extraction), the nonvolatile gums compounds remain with the oil. Various degumming techniques can then be used to remove the gums during subsequent oil refining after the oil containing gums is separated from the organic solvent. This can include mixing the oil containing the gums with an immiscible polar liquid (e.g., water, acidified solution, caustic solution). However, this results in oil losses due to entrainment and/or chemical reaction while extracting the gums, reducing total oil yield.

In accordance with some examples of the present disclosure, an oleaginous material is extracted using an alcohol-based solvent, such as a hydrous alcohol-based solvent The alcohol-based solvent can extract both oil and gums from the surrounding solid matter (e.g., cellular matter) forming the material being extracted. The resulting miscella stream can contain the solvent used for extraction, extracted oil, and extracted gums. The miscella stream can be subsequently separated into a solvent-rich phase (e.g., polar phase) and an oil-rich phase, with the extracted gums being carried with the solvent and concentrating in the solvent-rich phase. The solvent-rich phase can then be processed to separate and recover the extracted gums, as described in greater detail below. The separated gums may be further purified and sold as lecithin, a high-value food ingredient. By extracting and separating the gums in the solvent-rich phase instead of leaving the gums in the oil-rich phase for downstream separation (e.g., according to traditional organic solvent extraction processes), downstream degumming of the extracted oil may be reduced or eliminated and/or the amount of oil loss due to degumming may be meaningfully reduced, increasing the volume of saleable oil generated from the overall extraction process.

By extracting gums from the oleaginous material and separating the extracted gums with the extraction solvent, the gums are separated from the oil at the extraction stage of the process as opposed to during downstream refining of the extracted oil. This can allow the gums to be removed without the use of degumming chemicals or enzymes, as are typically required when degumming the extracted oil, which reduces processing cost. Further, by removing gums from the low-oil solvent-rich liquid, rather than extracted crude oil, oil loss during degumming is reduced and the resulting produced gums can have lower residual oil content.

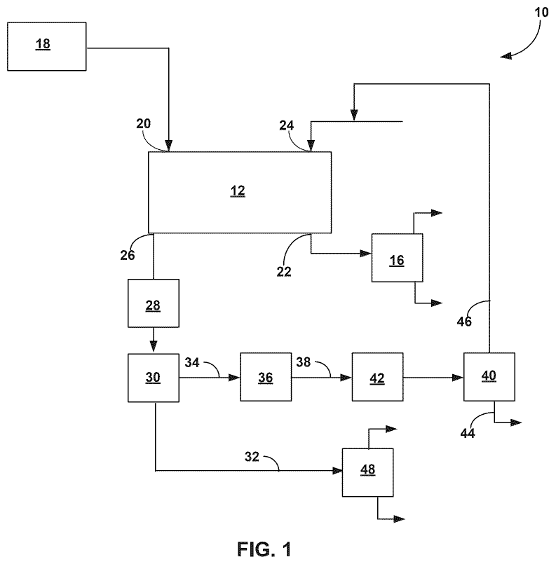

FIG. 1 is a block diagram illustrating an example extraction system 10 according to the disclosure in which gums are extracted and precipitated as part of a solvent extraction and recovery process. System 10 includes an extractor 12 and a desolventizer 16. System 10 is also illustrated as including a dryer 18 upstream of extractor 12. Extractor 12 has a feed inlet 20 that can receive a solid material after having undergone optional drying in dryer 18 to be subject to extraction within the extractor. Extractor 12 also has a feed outlet 22 that can discharge the solid particulate material after it has undergone extraction and has a lower concentration of extract than the fresh incoming material. Extractor 12 also has a solvent inlet 24 configured to introduce fresh solvent into the extractor and a solvent outlet 26 configured to discharge a miscella formed via extraction of extractable components from the solid material.

In operation, the solid material being processed is contacted with solvent within extractor 12 (e.g., in counter current fashion), causing components soluble within the solvent to be extracted from the solid material into the solvent. Extractor 12 can process any desired solid material using any suitable extraction fluid. Example types of solid material that can be processed using extractor 12 include, but are not limited to, plant-based materials containing gums including oleaginous matter, such as oil-bearing seeds and fruits like soybeans, rapeseed, sunflower seed, peanuts, cottonseed, palm kernels, and corn germ. The solid material being processed using extractor 12 can include gums. Gums are generally phospholipids that may include phosphatides. The oil fraction of the solid material may be entrained with the gums without itself being part of the gums.

Alcohol-based solvents that can be used for extraction from solid material include, but are not limited to, mono-hydroxyl or multi-hydroxyl (e.g., di-hydroxyl) alcohols having carbon chains 1 to 8 carbons in length, such as 1 to 4 carbons in length, or 2 to 3 carbons in length. For example, the alcohol-based solvent may be ethanol or isopropyl alcohol. In some examples, the alcohol-based solvent consists essentially of alcohol (e.g., with or without water). For example, the alcohol-based solvent may be a hydrous alcohol or an anhydrous alcohol solvent. In some examples, the alcohol-based solvent has greater than 90 weight percent alcohol and less than 10 weight percent water, such as greater than 95 weight percent alcohol and less than 5 weight percent water, or greater than 97 weight percent alcohol and less than 3 weight percent water.

In some implementations, the incoming solid material to be extracted in extractor 12 is mechanically pressed to remove a portion of the oil from the solid material with the resulting pressed material forming the solid material for subsequent solvent extraction. Additionally or alternatively, the solid material to be solvent extracted may be dried by dryer 18 before being extracted in extractor 12. Dryer 18 can reduce the amount of water in the solid material supplied to extractor 12. When using an alcohol-based solvent, the water content of the solid material introduced into the extractor may be controlled to prevent excess water from entering the extractor, which can dilute the solvent (e.g., reducing the effectiveness of the extraction and/or making solvent recovery challenging). When used, dryer 18 may dry the solid material at a temperature greater than 30° C., such as greater than 50° C., or greater than 60° C., greater than 70° C., greater than 80° C., or greater than 100° C. Additionally or alternatively, dryer 18 may dry the solid material at a temperature less than 125° C., such as less than 100° C., or less than 80° C. For example, dryer 18 may dry the solid material at a temperature below the boiling point of water. In some examples, dryer 18 may dry the solid material at a temperature ranging from 40° C. to 90° C., such as from 50° C. to 80° C. Dryer 18 may typically operate at atmospheric pressure although, in other examples, may be configured to operate at a non-atmospheric pressure (e.g., vacuum pressure, positive pressure).

In still other examples, in addition to or in lieu of drying the solid material with dryer 18, the solid material may be pre-treated with a water removal solvent to remove water from the material prior to introducing the material into an extractor. In particular, the material to be processed can be contacted with a water removal solvent that causes water to transfer from the material into the water removal solvent. The water removal solvent having an increased concentration of water attributable to the water removed from the material can then be separated from the material to produce a solvent-wetted material having a reduced concentration of water. This solvent-wetted material can then be introduced into the extractor, typically while still solvent-wetted although optionally with intermediate drying, to subsequently extract oil from the feedstock in the extractor. The water removal solvent may or may not contain the same alcohol as the alcohol-based solvent subsequently used in the extractor to extract oil from the feedstock. Additional details on example pre-treatment using a water removal solvent are described in U.S. patent application Ser. No. 18/680,990, titled “ALCOHOL PRETREATMENT TO REMOVE WATER TO PREPARE OLEAGINOUS MATERIAL FOR SUBSEQUENT ALCOHOL-BASED SOLVENT EXTRACTION,” the entire contents of which is incorporated herein by reference.

Extractor 12 can produce a solvent-wet solids stream that discharges through feed outlet 22 and a miscella stream that discharges through solvent outlet 26. The miscella stream contains oil and gums extracted from the solid material processed in extractor 12. The concentration of oil and gums in the miscella may vary, e.g., depending on the composition of the feedstock being processed and the size and operating rates of extractor 12. In some examples, however, the miscella discharging from extractor 12 may contain from an amount of gums that is within a range from 0.1 wt % of the oil concentration in the miscella to 2 wt % of the oil concentration in the miscella, such as from 0.5 wt % to 1.5 wt %, from 0.8 wt % to 1.2 wt %, or approximately 1.0 wt % (plus or minus ten percent). For example, a miscella having at 30 wt % oil content may have 0.3 wt % gum concentration; a miscella having a 75 wt % oil content may have 0.75 wt % gum concentration.

The miscella stream discharging from extractor 12 via miscella outlet 26 may be further processed separate the solvent from the oil and also to separate the extracted gums from the miscella, as discussed in greater detail below. To recover solvent from the solvent-wet solids stream and further prepare the residual solids material for end use, the solvent-wet solids stream may be desolventized using mechanical and/or thermal desolventization devices. In the example of FIG. 1, system 10 includes a desolventizer 16. Desolventizer 16 can be implemented using one or more stages of mechanical and/or thermal treatment to remove solvent from the solvent-wet solids stream, thereby producing a dried extracted solid material (which may also be referred to as a desolventized extracted solid material). It should be appreciated that reference to a dried and/or desolventized solid material refers to a material that is comparatively dried and desolventized and does not require complete drying or desolventization or that the material be devoid of solvent. Rather, the material may be dried and desolventized to a practical level effective for downstream use and/or processing.

In some examples, desolventizer 16 heats the extracted solid material (the solvent-wet solids stream) produced by extractor 12 to vaporize solvent from the stream to produce a dried solid material. While desolventizer 16 may inject steam into the extracted solid material in some implementations, in other implementations, desolventizer 16 may desolventize the extracted solid material without adding moisture to the material during desolventizing. For example, desolventizer 16 may directly and/or indirectly heat the extracted solid material without injecting steam into the extracted solid material. Desolventizer 16 may indirectly heat the extracted solid material by passing a heat transfer fluid through a tray that the extracted material contacts while passing through a desolventizing vessel and/or through a jacket surrounding at least a portion of the desolventizing vessel. Additionally or alternatively, desolventizer 16 may introduce a heated gas substantially devoid of moisture (e.g., dried air, nitrogen) into an interior of the desolventizing vessel and extracted solid material therein.

In different examples, desolventizer 16 can be implemented using a cooker, jacketed paddle mixer, bulk solids heat exchanger, and/or desolventizer-toaster. In any case, the solvent separated from the solvent-wet extracted solids stream via desolventizer 16 can be recycled back to extractor 12 for reuse (optionally with further processing, such as to decrease the water content in the solvent stream, before being returned to the extractor).

As noted above, extractor 12 produces a miscella stream that discharges through solvent outlet 26. This miscella stream can be further processed to help separate the oil fraction of the miscella stream from the solvent fraction and also to recover gums extracted into the miscella. In the example of FIG. 1, system 10 includes a first cooling unit 28 that is configured to receive the miscella stream and cool the stream to a first temperature to promote liquid-liquid phase separation between the polar alcohol-based solvent component of the miscella and the extracted oil component of the miscella. First cooling unit 28 may be implemented using one or more heat exchangers or other thermal transfer devices that reduce a temperature of the miscella stream to a temperature effective to cause phase separation.

The temperature to which first cooling unit 28 cools the miscella stream may be sufficiently low to promote phase separation between the oil phase and solvent phase while also being sufficiently high to avoid premature precipitation of gums in the miscella. For example, the temperature to which first cooling unit 28 cools the miscella stream may be sufficiently high such that less than 20 wt % of the gums extracted into the miscella precipitate upon cooling by first cooling unit 28, such as less than 10 wt %, less than 5 wt %, or less than 3 wt %. In practice, depending on the temperature to which first cooling unit 28 cools the miscella stream, some gums may precipitate, such as at least 1 wt % of the gums extracted into the miscella, at least 3 wt % of the gums extracted into the miscella, or at least 5 wt % of the gums extracted into the miscella. In some examples, first cooling unit 28 cools the miscella stream to a temperature within a range from 30 degrees Celsius to 50 degrees Celsius.

In contrast to the temperature to which first cooling unit 28 cools the miscella stream, the operating temperature of extractor 12 may be sufficiently hot to produce a miscella stream discharging from the extractor at a temperature greater than 50 degrees Celsius, such as greater than 60 degrees Celsius, or greater than 65 degrees Celsius. For example, the temperature of the miscella stream received from the extractor may range from 60 degrees Celsius to 90 degrees Celsius, such as from 65 degrees Celsius to 80 degrees Celsius, such as approximately 70 degrees Celsius.

Cooling the miscella stream to the first temperature can produce a solvent-rich phase separated from an oil-rich phase. A compositional gradient may exist between the solvent-rich phase and the oil-rich phase formed by cooling the miscella stream. In either case, in the example of FIG. 1, extraction system 10 includes a separator 30 to separate the solvent-rich phase from the oil-rich phase. The solvent-rich phase may be referred to as a light phase, while the oil-rich phase may be referred to as a heavy phase. Separator 30 may be implemented using a decanter (e.g., gravity decanter) and/or other liquid separation device, such as a centrifuge and/or cyclone. Separator 30 can separate the solvent-rich phase from the oil-rich phase to produce a separated oil-rich stream/heavy phase stream 32 and a separated solvent-rich stream/light phase 34. The two separate streams may be further processed.

The extracted gums may be substantially dissolved in the solvent phase of the miscella (e.g., with the phosphatides hydrating and solubilizing in the polar solvent phase). Accordingly, the separated solvent-rich stream 34 generated by separator 30 may contain a majority weight percent of the gums extracted by the solvent in extractor 12. For example, at least 60 wt % of the extracted gums in the miscella stream discharging from extractor 12 via miscella outlet 26 may separate into the separated solvent-rich rich phase 34 (with the remaining weight percent carrying with the separated oil-rich rich phase 32), such as at least 70 wt %, at least 80 wt %, at least 90 wt %, at least 95 wt %, or at least 98 wt %. The relative amount of gums in separated oil-rich rich stream 32 compared to the amount in separated solvent-rich rich stream 34 may depend, e.g., on the amount of solvent carryover into the oil-rich stream and the amount of oil carryover into the solvent-rich stream and the amount of gums precipitated by first cooling unit 28.

Some or all of the separated solvent-rich stream 34 generated by separator 30 may be further processed through a second cooling unit 36 that is configured to receive the separated solvent-rich stream 34 and further cool the stream to a second temperature less than the first temperature to which first cooling unit 28 cooled the full miscella stream. Second cooling unit 36 can cool the separated solvent-rich stream 34 to a second temperature that is effective to precipitate the extracted gums in the separated solvent-rich stream, thereby forming precipitated extracted gums. For example, the second temperature may be effective to precipitate a majority weight percent of the gums in the separated solvent-rich stream 34, such precipitating at least 60 wt % of the extracted gums in the separated solvent-rich stream 34, at least 70 wt %, at least 80 wt %, at least 90 wt %, at least 95 wt %, at least 98 wt %, or substantially all (e.g., 100 wt %) of the extracted gums in the separated solvent-rich stream 34. Second cooling unit 36 may be implemented using one or more heat exchangers or other thermal transfer devices that reduce a temperature of the miscella stream to a temperature effective to cause phase separation.

Second cooling unit 36 can cool the separated solvent-rich stream 34 to a second temperature less than the first temperature to which first cooling unit 28 cooled the full miscella stream. The second temperature may be least 5 degrees Celsius less than the first temperature, such as at least 10 degrees Celsius less than the first temperature, at least 15 degrees Celsius less than the first temperature, at least 20 degrees Celsius less than the first temperature, at least 25 degrees Celsius less than the first temperature, or at least 30 degrees Celsius less than the first temperature. For example, the second temperature may be within a range from 15 degrees Celsius less than the first temperature to 40 degrees Celsius less than the first temperature, such as from 20 degrees Celsius to 30 degrees Celsius less than the first temperature. In some examples, second cooling unit 36 cools the separated solvent-rich phase 34 to a temperature within a range from 0 degrees Celsius to 30 degrees Celsius, such as from 0 degrees Celsius to 10 degrees Celsius.

Second cooling unit 36 can generate a cooled separated solvent-rich phase stream containing precipitated extracted gums 38. The cooled separated solvent-rich phase stream containing precipitated gums 38 can be supplied to a separator 40 to separate the solid precipitated extracted gums from the residual liquid separated solvent-rich stream. In some examples, the cooled separated solvent-rich phase stream containing precipitated gums 38 is supplied substantially at the second temperature to which the stream was cooled by second cooling unit 36 (e.g., a temperature plus or minus 10%). In other examples, the cooled separated solvent-rich phase stream containing precipitated gums 38 may be heated before being supplied to separator 40. For example, in FIG. 1, system 10 is illustrated as including a heating unit 42 positioned between second cooling unit 36 and separator 40. Heating unit 42 can heat the cooled separated solvent-rich phase stream containing precipitated extracted gums 38 to an elevated temperature before separating precipitated gums from the stream via separator 40.

In practice, when separated solvent-rich stream 34 is cooled by second cooling unit 36 to precipitate extracted gums, residual oil in the separated solvent-rich stream may solidify, agglomerate, and/or phase separate from the separated solvent-rich stream 34. This can result in a stream after second cooling unit 36 that includes precipitated gums, phase separated oil, and solvent. When the stream is subsequently supplied to separator 40, at least some of the phase separated oil may separate with the precipitated gums from the solvent. This can interfere with the separation process, purity of the separated precipitated gums, and/or cause other processing issues.

For these and other reasons, in some examples, the cooled separated solvent-rich phase stream containing precipitated extracted gums 38 is heated before separating the extracted gums from the stream. Heating the stream via heating unit 42 can solubilize (e.g., re-dissolve) at least a portion of the oil that phase separated as a result of colling separated solvent-rich stream 34 via second cooling unit 36. In some examples, heating unit 42 is implemented using one or more heat exchangers.

Heating unit 42 can heat the cooled separated solvent-rich phase stream containing precipitated extracted gums 38 to a temperature effective to substantially solubilize the phase separated oil back into the solvent phase without substantially dissolving the precipitated gums back into the solvent phase. For example, heating unit 42 can heat the cooled separated solvent-rich phase stream containing precipitated extracted gums 38 to a temperature effective to substantially solubilize at least 50 wt % of any phase separated oil back into the solvent phase, such as at least 60 wt %, at least 70 wt %, at least 80 wt %, at least 90 wt %, or at least 95 wt %. At the same time, the temperature to which heating unit 42 heats the cooled separated solvent-rich phase stream containing precipitated extracted gums 38 may be effective such that less than 20 wt % of the precipitated gums back are dissolved back into the solvent phase, such as less than 15 wt %, less than 10 wt %, less than 5 wt %, less than 3 wt %, or less than 1 wt %. In some examples, heating unit 42 heats the cooled separated solvent-rich phase stream containing precipitated extracted gums 38 to a temperature within a range from 20 degrees Celsius below the extraction temperature to a temperature 20 degrees Celsius above the extraction temperature (limited by boiling point), such as from 10 degrees Celsius below the extraction temperature to a temperature 10 degrees Celsius above the extraction temperature (again limited by boiling point).

Independent of whether the cooled separated solvent-rich phase stream containing precipitated extracted gums 38 is or is not heated prior to being supplied to separator 40, the separator can separate the solid precipitated extracted gums from the residual liquid separated solvent-rich stream. This can produce a separated gums stream 44 and a degummed solvent-rich stream 46. Degummed solvent-rich steam 46 may be substantially devoid of gums but may include some residual amount of gums carried over through processing. Thus, reference to stream 46 as being a degummed solvent-rich stream 46 does not require that the stream be devoid of gums but, instead, reflects that the stream contains a reduced amount of gums compared to solvent-rich phase entering separator 40. Separator 40 can be implemented using one or more solids separation units, such as a filter, settling tank, centrifuge, and/or other solids separation equipment. Separated gums stream 44 may be further purified to provide food-grade lecithin. Degummed solvent-rich steam 46 can be supplied back to extractor 12 directly (e.g., by being supplied to a solvent inlet of the extractor) or indirectly (e.g., by being supplied to a solvent tank which, in turn, supplies solvent to the extractor). In some examples, degummed solvent-rich steam 46 may be recycled, directly or indirectly, back to the fresh solvent inlet 24 of extractor 12. In other examples, degummed solvent-rich steam 46 may be recycled, directly or indirectly, back to a different solvent inlet of extractor 12 (e.g., to a downstream extraction stage in a direction of solvent flow).

For example, the degummed solvent-rich steam 46 may be recycled back to extractor 12 and introduced into the extractor at a location where a composition of miscella in the extractor is substantially the same as a composition of the concentrated solvent stream. For example, the concentration of the solvent in the degummed solvent-rich steam 46 (e.g., calculated by dividing the weight of the alcohol and water by the combined weight of the alcohol, water, and oil) may be within ±20 weight percent of the concentration of the solvent in the miscella in the extraction stage of the extractor to which the degummed solvent-rich steam 46 is recycled, such as within ±10 weight percent, or within ±5 weight percent. Additionally or alternatively, the concentration of the oil in the degummed solvent-rich steam 46 (e.g., calculated by dividing the weight of the oil by the combined weight of the alcohol, water, and oil) may be within ±20 weight percent of the concentration of the oil in the miscella in the extraction stage of the extractor to which the degummed solvent-rich steam 46 is recycled, such as within ±10 weight percent, or within ±5 weight percent.

In other examples, degummed solvent-rich steam 46 may be processed to a thermal separator where solvent and redissolved oil and/or gums are further separated and removed from the solvent. This can purify the solvent in degummed solvent-rich steam 46 for recycling back to extractor 12. The oil and/or gums thermally separated from degummed solvent-rich steam 46 can be discarded or otherwise removed from the process.

The degummed solvent-rich steam 46 generated by separator 40 may be substantially pure solvent (e.g., substantially devoid of oil). In some examples, the degummed solvent-rich steam 46 generated by separator 40 may have greater than 90 weight percent alcohol and less than 10 weight percent oil, such as greater than 95 weight percent alcohol and less than 5 weight percent oil, or greater than 98 weight percent alcohol and less than 2 weight percent oil.

As briefly noted above, the oil-rich stream/heavy phase stream 32 generated by separator 30 can be further processed. In the example of FIG. 1, extraction system 10 includes thermal separator 48. Thermal separator 48 can receive some or all of oil-rich stream 32 produced by separator 30 to remove residual solvent from the stream. Thermal separator 48 can be implemented using a stripping column (e.g., that utilizes steam or other motive gas), a distillation column, a flash drum, an evaporator, and/or other thermal separation device. In either case, the solvent separated from the separated via thermal separator 48 can be recycled, directly or indirectly, back to solvent inlet 24 of extractor 12 for reuse.

Extractor 12 in any of the foregoing examples can be implemented using any suitable type of extractor configuration. For example, extractor 12 may be an immersion extractor, a percolation extractor, or yet other type of extractor design. In one example, extractor 12 is a shallow bed continuous loop extractor.

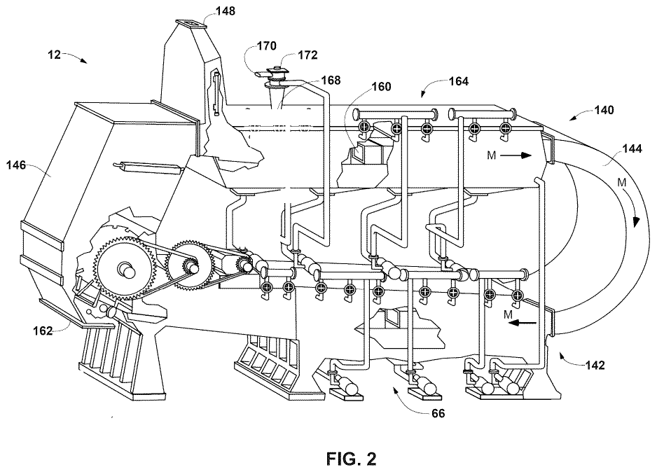

FIG. 2 is an illustration of an example extractor configuration that can be used for extractor 12. In the example shown, extractor 12 includes a housing defining a passageway in the form of a loop disposed in a vertical plane. The extractor can include upper and lower extraction sections 140, 142 each with a series of extraction chambers, a generally arcuate hollow transfer section 144 having its opposite upper and lower ends connected to first ends of the upper and lower extraction sections respectively, and a hollow, generally vertical return section 146 connected at its upper and lower ends respectively to the other ends of the upper and lower extraction sections. The upper extraction section can include an inlet portion 148 for delivery of solid material to the interior thereof in closely spaced relation to the upper end of the return section, and the lower end of the return section can define an opening 162 for discharge of the material after the product-of-interest has been extracted therefrom. The number of extraction chambers, or stages, provided by the extractor can vary depending on the desired size of the extractor. The extractor includes at least one extraction chamber, or stage, and typically includes multiple stages (e.g., 6 stages, 8 stages, or more). A Model III extractor commercially available from Crown Iron Works Company of Minneapolis, MN, is a specific example of an extractor of this type.

In such an extractor, a conveyor system 160 can extend longitudinally through the looped passageway and be driven in a material flow direction “M” to move the material as a bed from the inlet portion 148 through the upper extraction section 140 toward and downwardly through the transfer section 144, and through the lower extraction section 142 toward the lower end of the return section and the discharge opening 162. In some embodiments, the conveyor system includes a pair of laterally spaced endless link chains and a plurality of longitudinally spaced flights that extend transversely of the chains. A motor and gearing may be provided to drive the conveyor.

In some configurations, a fluid supply system 164 can be disposed above the solid materials and configured to apply a fluid to the solid materials in each extraction chamber, and a fluid removal system 166 can be disposed below the solid materials and configured for removing the fluid after it has passed through the solid materials in each extraction chamber. In some embodiments, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed solid material, allowing the extraction fluid to then percolate through the material. The fluid removal system may include a network of drains, pumps, and pipes to collect the fluid after it has percolated through the solid material in each extraction chamber and deliver it to the fluid supply system of another extraction chamber or remove it from the system.

As shown in FIG. 2, fluid having passed through the solid material is collected by the fluid removal system 166 and delivered to a separation device 168 to separate solid fines from the fluid before fluid discharge. Separation device 168 may be implemented as a hydrocyclone, a centrifuge, and/or a mechanical filter. An outlet conduit 170 of separation device 168 can deliver the fluid, generally a mixture of extraction fluid and soluble components extracted from the solid material into the extraction fluid (e.g., oil and gums) (commonly known as “miscella”), for downstream processing as described herein, for separating the extraction fluid from the material extracted from the solid material being processed. A separate outlet 172 of separation device 168 can deliver a stream containing particulate matter separated from the miscella for discharge and/or further processing.

As material is conveyed through extractor 12, spray headers from the fluid supply system 164 spray recycled extraction fluid on the top of the material. The material percolates through the material and through the screen, where it is collected in the network of drainpipes and delivered back to the network of spray headers where it is reapplied to the solid material in a different extraction chamber. In some embodiments, fresh extraction fluid is applied to the material in the last extraction chamber before the solid material discharge 162. For example, fresh extraction fluid may be applied to the material in the last extraction chamber before discharge 162 and, after being collected at the bottom of the chamber, recycled and applied on top of solid material in an adjacent upstream extraction chamber. By recycling collected extraction fluid from one extraction chamber to an adjacent upstream extraction chamber, liquid extraction fluid and solid material being processed can move in countercurrent directions through the extractor. For example, as extraction fluid is conveyed sequentially through adjacent extraction chambers between a fresh extraction fluid inlet adjacent discharge 162 and an enriched extraction fluid outlet adjacent inlet 148, the concentration of extract relative to extraction fluid increases from a relatively small extract-to-extraction fluid ratio to a comparatively large extract-to-extraction fluid ratio. Similarly, as the solid material is conveyed in the opposing direction, the concentration of extract in the solid feedstock decreases from a comparatively high concentration at the inlet 148 to a comparatively low concentration at the outlet 162.

Configuring an extraction system, such as extraction system 10, to extract, precipitate, and recover gums can provide a variety of operational and performance advantages. In some examples, such a configuration can allow the oil produced by the system (e.g., oil coming off thermal separator 48) to be further used and/or processed without requiring an additional degumming step during subsequent oil refining and/or reduce the amount of downstream degumming performed. This can reduce or eliminate the need for degumming chemicals or enzymes during downstream oil processing. Further, by removing gums from the low-oil solvent-rich liquid, rather than extracted crude oil, oil loss during degumming is reduced and the resulting produced gums can have lower residual oil content. This can increase the amount of extracted oil generated by extraction system 10 per unit of incoming solid feed, improving the oil recovery yield and economics of the process, compared to performing downstream degumming on the extracted oil stream.

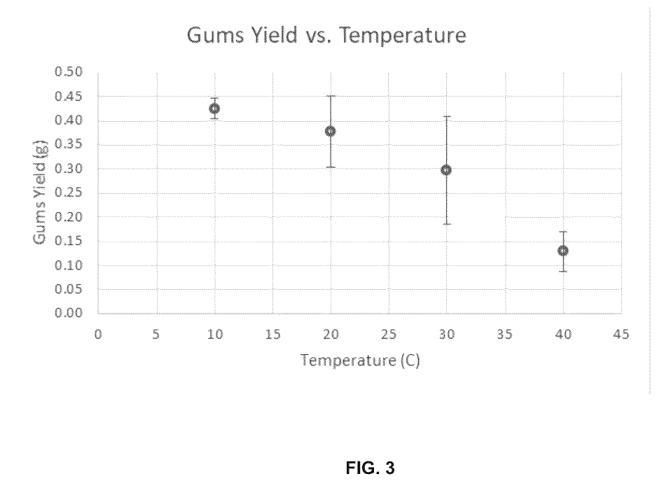

FIG. 3 is a plot of experimental gums yield data showing the amount of precipitated gums recovered at different cooling temperatures. The experiment utilized 225 grams of dehulled, flaked, and dried soybeans, dried to nominal 2.3% moisture at 74 C, extracted in a batch percolation column at 70 C with 675 g of ethanol containing <0.75% water. Miscella was captured in a controlled temperature vessel maintained at different temperatures (as shown on x-axis of graph) for the duration of the extraction. Miscella was then reheated to 67 C and filtered. Filtrate was washed with cold acetone at −5 C to remove entrained oil.

In practice, a gums-containing stream being processed according to systems and techniques of the disclosure may undergo a holding or residence time in which the stream is held after one processing step before being subjected to a subsequent processing step. The holding period can allow gums to precipitate and/or agglomerate before further processing.

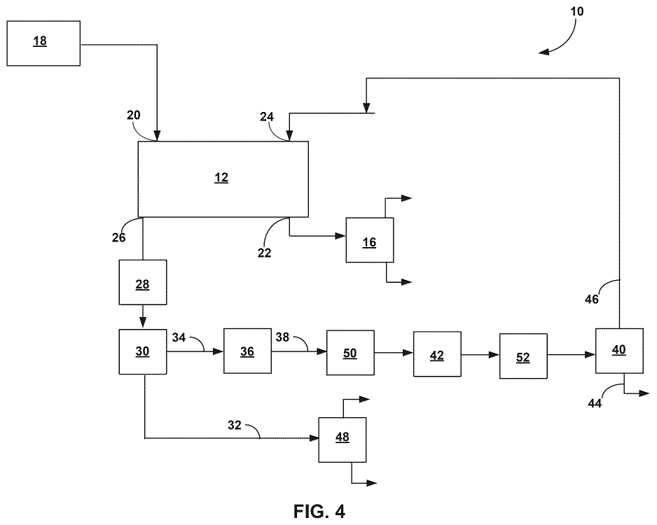

FIG. 4 is a block diagram illustrating extraction system 10 from FIG. 1 where like reference numerals refer to like features discussed above with respect to FIG. 1. In the example of FIG. 4, extraction system 10 is shown as further including or more holding tanks operable to provide a residence holding time for the stream being processed before a downstream processing step.

In particular, in the example of FIG. 4, extraction system 10 is shown as including a holding tank 50 that receives the cooled separated solvent-rich phase stream containing precipitated extracted gums 38 before optional heating unit 42. Holding tank 50 can hold the cooled separated solvent-rich phase stream containing precipitated extracted gums 38 for a period of time before being discharged for further downstream processing (e.g., to heater unit 42 and/or separator 40). That period of time may be sufficient to allow precipitated gums 38 to agglomerate after chilling, forming larger aggregate particle sizes that are less susceptible to redissolution during subsequent heating and/or easier to separate by separator 40. The period of time may be within a range from 5 minutes to 2 hours, such as from 5 minutes to 1 hour. For example, the period of time may be less than 90 minutes, less than 60 minutes, less than 45 minutes, less than 30 minutes, less than 20 minutes, less than 15 minutes, or less than 10 minutes. Within any of the foregoing up end ranges, the period of time may be greater than 1 minute, such as greater than 2 minutes, greater than 5 minutes, greater than 10 minutes, greater than 15 minutes, greater than 20 minutes, greater than 30 minutes, or greater than 45 minutes.

Holding tank 50 may or may not be agitated. Holding tank 50 may employ light agitation such as low-shear impeller mixing (e.g., pitched-blade or hydrofoil at low tip speed), slow-speed anchor/scraper agitators to maintain uniform suspension without breaking flocs, or mild recirculation loops with low-flow side returns. “Light agitation” generally targets bulk turnover and temperature homogeneity while minimizing shear, typically using low power-per-volume, low Reynolds number operation, and avoiding high-velocity jets or close-clearance high-shear devices to preserve precipitated gum aggregates for downstream separation.

In addition to or in lieu of configuring extraction system 10 with holding tank 50, extraction system 10 may include a feed tank 52 downstream of heating unit 42 and upstream of separator 40. In practice, some portion of the precipitated gums 38 in the cooled separated solvent-rich phase stream may redissolve and go back into solution upon being heated by heating unit 42. Passing the heated stream discharging from heating unit 42 through a mechanical pump may cause further solubilization of the heated precipitated gums. In these and other examples, feed tank 52 may be provided to receive the heated stream discharging from heating unit 42 before supplying separator 40.

Feed tank 52 may or may not employ light agitation, as discussed above with respect to holding tank 50. Feed tank 52 can hold the heated stream received from heating unit 42 for a period of time, e.g., to allow for agglomeration of precipitated gums 38 after heating and/or phase separation between the solvent-rich and oil-rich phases. The period of time may be within a range from 1 minute to 30 minutes, such as from 5 minutes to 20 minutes. In some applications, feed tank 52 is positioned to deliver the heated precipitated gums 38 to separator 40 via gravity (e.g., in instances in which separator 40 is implemented as a gravity separator) without pumping between the feed tank and separator, which may otherwise further break up and solubilize agglomerated gums particles.

As previously discussed with respect to FIG. 1, extraction system 10 can include first cooling unit 28 that is configured to receive the miscella stream and cool the stream to a first temperature to promote liquid-liquid phase separation between the polar alcohol-based solvent component of the miscella and the extracted oil component of the miscella. The temperature to which first cooling unit 28 cools the miscella may be effective to promote phase separation while minimizing the amount of extracted gums that precipitate (e.g., which can become entrained with the oil-rich phase). In practice, however, some portion of the extracted gums may precipitate when cooling the miscella with first cooling unit 28 that may not completely separate into the solvent-rich phase after undergoing subsequent separation by separator 30.

Thus, the gums that precipitate as a result of cooling in first cooling unit 28 may be referred to as the first precipitated gums. When a solvent-oil interface exits between the solvent-rich phase and the oil-rich phase following cooling in first cooling unit 28 (e.g., characterized by a mixture and solvent that does not cleanly resolve into the solvent-rich phase and the oil-rich phase), the first precipitated gums may divide into the three groups: first precipitated gums that are contained within the solvent-rich phase and are separated the solvent-rich phase 34 by separator 30, settled gums that that settle to the bottom and are separated with the oil-rich phase 32 by separator 30, and interface gums. Depending on how separator 30 is operated and configured (e.g., draw locations for gravity-settled layers), the solvent-oil interface and interface gums contained within the solvent-oil interface may be separated with solvent-rich phase 34 (or, in other examples, with oil-rich phase 32). In the former case, the settled gums are conveyed with the oil-rich phase 32 for oil refining while the interface gums are carried forward with the solvent-rich phase 34 for further processing and separation.

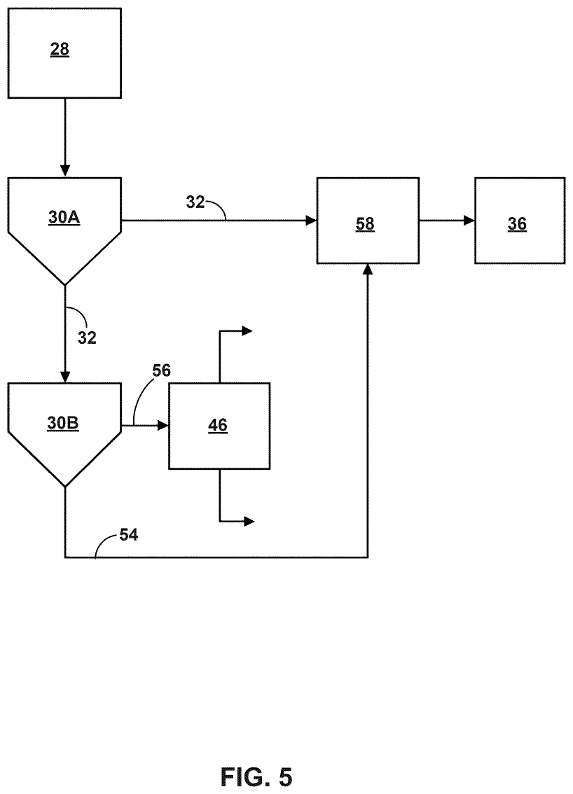

In accordance with some examples of the disclosure, separator 30 may be implemented using multiple stages of separation (e.g., in series) to reduce the amount of gums carried into the oil-rich phase 32, helping to achieve a cleaner resultant oil stream from the extraction system. FIG. 5 is a block diagram illustrating a portion of extraction system 10 from FIGS. 1 and 4 showing an example arrangement of processing steps that can be implemented to process the miscella received from extractor 12. Like reference numerals refer to like features discussed above.

In the example of FIG. 5, extraction system 10 is shown including first cooling unit 28 that is configured to receive the miscella stream and cool the stream to a first temperature to promote liquid-liquid phase separation between the polar alcohol-based solvent component of the miscella and the extracted oil component of the miscella. First cooling unit 28 generates a cooled miscella stream that includes a first precipitated portion of gums. The cooled miscella stream containing the first precipitated portion of gums can be conveyed to and received by a first separator 30A, implemented using any of the example separators described above with respect to separator 30. First separator 30A can separate the solvent-rich phase of the cooled miscella stream from the oil-rich phase of the cooled miscella stream to produce a separated oil-rich phase stream/heavy phase stream 32 and a separated solvent-rich phase stream/light phase 34, as also discussed above. The separated oil-rich phase stream 32 can contain precipitated settled gums from the first precipitated portion of gums. The separated solvent-rich phase stream 34 can contain precipitated gums solubilized in the light phase from the first precipitated portion of gums and interface gums from the first precipitated portion of gums.

In the example of FIG. 5, extraction system 10 is shown as also including a second separator 30B, implemented using any of the example separators described above with respect to separator 30. The separated oil-rich phase stream 32 containing precipitated settled gums can be conveyed to and received by second separator 30B. Second separator 30B can separate a heavy phase 54 containing the precipitated settled gums and entrained oil from a light phase 56 containing oil having a reduced amount of precipitated settled gums (e.g., substantially devoid of precipitated settled gums). The light phase 56 from second separator 30B can processed in downstream thermal separator 48, as discussed above. The heavy phase 54 containing settled precipitated gums and entrained oil from second separator 30B can be processed in various ways. In some examples, the heavy phase 54 containing settled precipitated gums is mixed with the separated solvent-rich phase stream 34 from first separator 30A for further processing. For example, the heavy phase 54 containing settled precipitated gums can be mixed with the separated solvent-rich phase stream 34 via a mixer 58 before being delivered to second cooling unit 36 and further processing, as discussed above.

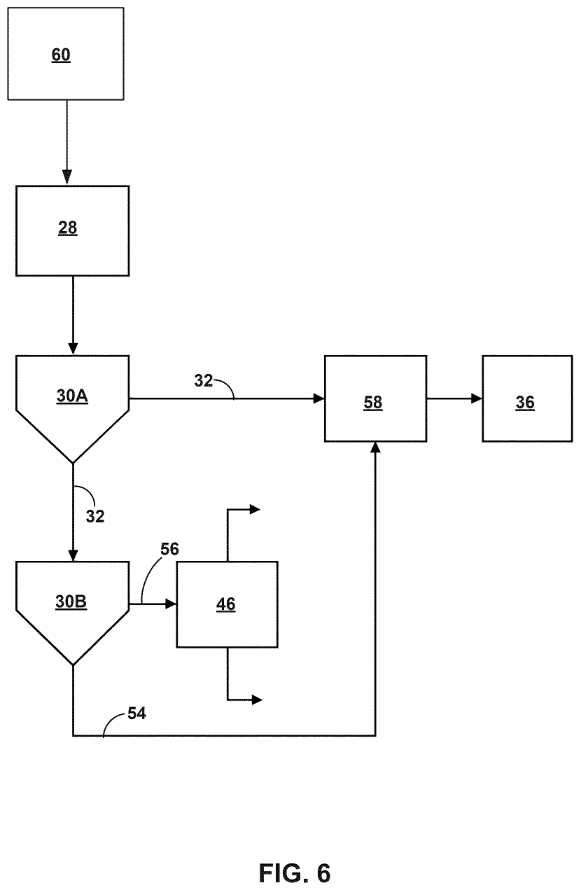

FIG. 6 is a block diagram illustrating another configuration of the example portion of extraction system 10 from FIGS. 1 and 4 where like reference numerals refer to like features discussed above. In the example of FIG. 6, extraction system 10 is shown as further including a holding tank 60 downstream of first cooling unit 28 and upstream of first separator 30A. Holding tank 60 may or may not employ light agitation, as discussed above with respect to holding tank 50.

Holding tank 50 can receive and hold the cooled miscella stream received from first cooling unit 28 for a period of time, e.g., effective to allow the precipitated gums in the interface layer to settle through the interface and become settled gums that are separated into the heavy phase generated by first separator 30A. The period of time may be within a range from 5 minute to 1 hour, such as from 5 minutes to 45 minutes, or from 10 minutes to 30 minutes.

The cooled miscella stream containing the first precipitated portion of gums can be conveyed from holding tank 60 and received by first separator 30A. First separator 30A can separate the solvent-rich phase of the cooled miscella stream. The separated oil-rich phase stream 32 generated by first separator 30A can contain precipitated settled gums. The separated solvent-rich phase stream 34 generated by first separator 30A can contain precipitated gums solubilized in the light phase. As in the example of FIG. 5, second separator 30B can separate a heavy phase 54 containing the precipitated settled gums and entrained oil from a light phase 56 containing oil having a reduced amount of precipitated settled gums (e.g., substantially devoid of precipitated settled gums). The light phase 56 from second separator 30B can processed in downstream thermal separator 48, as discussed above. The heavy phase 54 containing settled precipitated gums and entrained oil from second separator 30B can be processed, such as by mixing with separated solvent-rich phase stream 34 via mixer 58.

Systems and techniques according to the disclosure can efficiently control the precipitation and separation of the gums from the miscella stream generated from extraction of a solid feedstock with an alcohol-based solvent. The resulting separated gums stream can contain a very low amount of entrained oil compared to a gums stream generated in a traditional hexane extraction process that uses a downstream water degumming process. This reduces the amount of oil loss attributable to oil entrainment in the separated gums stream. Moreover, the amount of residual gums in the extracted oil stream may be a very low, e.g., compared to a traditional hexane extraction process, producing an oil stream that requires little or no downstream degumming.

For instance, separated gums stream 44 may contain less than 20 wt % oil on a solvent-free basis (the weight percentage of oil excluding the weight of any solvent in the stream), such as 15 wt % or less, or 10 wt % or less. For example, separated gums stream 44 may contain from 1 wt % oil on a solvent-free basis to 20 wt % oil on a solvent-free basis, such as 10 wt % oil on a solvent-free basis to 18 wt % oil on a solvent-free basis. By contrast, to a gums stream generated in a traditional hexane extraction process that uses a downstream water degumming process may typically contain from 30-35 wt % oil on a solvent-free basis, resulting in excess oil loss and reduced process economics.

Various examples have been described. These and other examples are within the scope of the following claims.

1. A method comprising:
conveying an oleaginous material to be processed in a conveyance direction through an extractor and conveying a solvent comprising alcohol in a countercurrent direction from the conveyance direction through the extractor, thereby generating an extracted material stream and a miscella stream comprising extracted oil and extracted gums;
cooling the miscella stream to a first temperature to form a solvent-rich phase comprising the extracted gums dissolved in the solvent-rich phase and an oil-rich phase comprising the extracted oil;
separating the solvent-rich phase from the oil-rich phase to form a separated oil-rich stream and a separated solvent-rich stream;
cooling the separated solvent-rich stream to a second temperature less than the first temperature, the second temperature being effective to precipitate the extracted gums in the separated solvent-rich stream thereby forming precipitated extracted gums; and
separating the precipitated extracted gums from the separated solvent-rich stream.

2. The method of claim 1, wherein separating the precipitated extracted gums from the separated solvent-rich stream comprises filtering the precipitated extracted gums from the separated solvent-rich stream.

3. The method of claim 1, further comprising, after cooling the separated solvent-rich stream to the second temperature and prior to separating the precipitated extracted gums from the separated solvent-rich stream, heating the separated solvent-rich stream comprising the precipitated extracted gums.

4. The method of claim 3, wherein:
the separated solvent-rich stream comprises residual oil;
cooling the separated solvent-rich stream to the second temperature comprises forming an oil phase of the residual oil and a solvent phase comprising the precipitated extracted gums; and
heating the separated solvent-rich stream comprise dissolving the oil phase formed while cooling the separated solvent-rich stream to the second temperature with the solvent phase.

5. The method of claim 3, further comprising, after cooling the separated solvent-rich stream to the second temperature, holding the separated solvent-rich stream comprising precipitated extracted gums in a holding tank for a period of time within a range form 5 minutes to 1 hour prior to heating the separated solvent-rich stream comprising the precipitated extracted gums.

6. The method of claim 3, further comprising, after heating the separated solvent-rich stream comprising precipitated extracted gums, holding a resulting heated stream in a feed tank, and subsequently delivering the resulting heated stream from the feed tank to a downstream separator via gravity without intervening pumping.

7. The method of claim 1, wherein the second temperature is at least 10 degrees Celsius less than the first temperature.

8. The method of claim 1, wherein:
the first temperature is within a range from 30 degrees Celsius to 50 degrees Celsius;
the second temperature is within a range from 0 degrees Celsius to 30 degrees Celsius; and
the second temperature is at least 10 degrees Celsius less than the first temperature.

9. The method of claim 1, wherein separating the solvent-rich phase from the oil-rich phase comprises decanting the solvent-rich phase from the oil-rich phase.

10. The method of claim 1, wherein separating the precipitated extracted gums from the separated solvent-rich stream comprises forming a degummed solvent-rich stream, and further comprising recycling the degummed solvent-rich stream to the extractor.

11. The method of claim 1, wherein separating the solvent-rich phase from the oil-rich phase comprises:
performing a first separation to produce a first light phase comprising the separated solvent-rich stream and a first heavy phase comprising the separated oil-rich stream; and
performing a second separation of the first heavy phase to produce a second heavy phase containing precipitated settled gums and entrained oil and a second light phase comprising oil having a reduced amount of precipitated settled gums.

12. The method of claim 11, further comprising combining the second heavy phase containing precipitated settled gums with the first light phase comprising the separated solvent-rich stream to provide a combined stream, wherein cooling the separated solvent-rich stream to the second temperature comprises cooling a combined stream to the second temperature.

13. The method of claim 1, wherein:
the alcohol is ethanol;
the precipitated extracted gums comprise phospholipids; and
the separated gums stream contains less than 20 wt % oil on a solvent-free basis.

14. A method comprising:
extracting oil and gums from an oleaginous material using a solvent comprising alcohol to form an extracted material stream and a miscella stream comprising extracted oil and extracted gums;
cooling the miscella stream to a first temperature to form a solvent-rich phase comprising the extracted gums dissolved in the solvent-rich phase and an oil-rich phase comprising the extracted oil;
separating the solvent-rich phase from the oil-rich phase to form a separated oil-rich stream and a separated solvent-rich stream;
cooling the separated solvent-rich stream to a second temperature less than the first temperature and thereby precipitating the extracted gums in the separated solvent-rich stream thereby forming precipitated extracted gums and further causing phase separation of residual oil carried with the separated solvent-rich stream;
heating the separated solvent-rich stream to cause the residual oil phase separated when cooling the separated solvent-rich stream to the second temperature to solubilize without substantially dissolving the precipitated extracted gums; and
separating the precipitated extracted gums from the separated solvent-rich stream.

15. The method of claim 14, wherein separating the precipitated extracted gums from the separated solvent-rich stream comprises one or more filtering, centrifuging, and/or gravity settling the precipitated extracted gums from the separated solvent-rich stream.

16. The method of claim 14, further comprising, after cooling the separated solvent-rich stream to the second temperature, holding the separated solvent-rich stream comprising precipitated extracted gums in a holding tank for a period of time within a range from 5 minutes to 1 hour prior to heating the separated solvent-rich stream comprising the precipitated extracted gums.

17. The method of claim 14, wherein:
the first temperature is within a range from 30 degrees Celsius to 50 degrees Celsius;
the second temperature is within a range from 0 degrees Celsius to 30 degrees Celsius, such as from 0 degrees Celsius to 10 degrees Celsius; and
the second temperature is at least 10 degrees Celsius less than the first temperature.

18. The method of claim 14, wherein:
separating the solvent-rich phase from the oil-rich phase comprises decanting the solvent-rich phase from the oil-rich phase; and
separating the precipitated extracted gums from the separated solvent-rich stream comprises forming a degummed solvent-rich stream, and further comprising recycling the degummed solvent-rich stream to the extractor.

19. The method of claim 14, wherein separating the solvent-rich phase from the oil-rich phase comprises:
performing a first separation to produce a first light phase comprising the separated solvent-rich stream and a first heavy phase comprising the separated oil-rich stream; and
performing a second separation of the first heavy phase to produce a second heavy phase containing precipitated settled gums and entrained oil and a second light phase comprising oil having a reduced amount of precipitated settled gums.

20. The method of claim 14, wherein:
the alcohol is ethanol;
the precipitated extracted gums comprise phospholipids; and
the separated gums stream contains less than 20 wt % oil on a solvent-free basis.
